(19) United States
(12) Patent Application Publication
(10) Pub. No.: US 2017/0103368 A1
(43) Pub. Date: Apr. 13, 2017

(54) DATA PROCESSOR

(71) Applicant: Accenture Global Services Limited, Dublin (IE)

(72) Inventors: Vivek GUPTA, Delhi (IN); Deepak AGGARWAL, Delhi (IN); Shipra KAKKAR, Haryana (IN); Shekar Nalle Pilli VENKATESWARA, Vienna, VA (US)

(21) Appl. No.: 15/291,875

(22) Filed: Oct. 12, 2016

(30) Foreign Application Priority Data
Oct. 13, 2015 (IN) 5478/CHE/2015

(51) Int. Cl. G06Q 10/10

(52) U.S. Cl. CPC G06Q 10/1053; G06Q 10/1093

(57) ABSTRACT

A device may receive data from a user. The device may automatically evaluate the data to generate a set of recommendations, where each of the recommendations relates to a recommended action to be taken by the user. The device may select a recommendation from the set of recommendations based on a set of decision criteria. The set of decision criteria may relate to a feasibility of implementing the recommendation. The device may identify a plurality of users to implement the recommendation selected from the set of recommendations. The device may provide, to each respective user of the plurality of users, respective information identifying a respective portion of the recommendation that is to be implemented by the respective user.

### RELATED APPLICATION

This application claims priority under 35 U.S.C. §119 to Indian Patent Application No. 5478/CHE/2015, filed on Oct. 13, 2015 the content of which is incorporated by reference herein in its entirety

### BACKGROUND

A human resources manager at a company may set a goal for diversity within the company. For example, at a company with a gender imbalance among managers of the company (e.g., a greater quantity of male managers than female managers, a greater quantity of female managers than male managers, etc.), the human resources manager may set a goal relating to reducing the gender imbalance (e.g., hiring more female managers relative to male managers, hiring more male managers relative to female managers, etc.). The human resources manager may achieve an employment diversity goal by instructing hiring personnel to hire additional employees.

### SUMMARY

According to some possible implementations, a device may include one or more processors. The one or more processors may receive data from a user. The one or more processors may automatically evaluate the data to generate a set of recommendations, where each of the recommendations relates to a recommended action to be taken by the user. The one or more processors may select a recommendation from the set of recommendations based on a set of decision criteria. The set of decision criteria may relate to a feasibility of implementing the recommendation. The one or more processors may identify a plurality of users to implement the recommendation selected from the set of recommendations. The one or more processors may provide, to each respective user of the plurality of users, respective information identifying a respective portion of the recommendation that is to be implemented by the respective user.

According to some possible implementations, a non-transitory computer-readable medium may store one or more instructions that, when executed by one or more processors, may cause the one or more processors to receive information identifying an employment diversity goal for a company. The employment diversity goal may be related to improving diversity among a group of employees at the company. The group of employees may be a subset of employees at the company that have a common geographic location, that have a common employment status, or that work for a common business unit. The one or more instructions, when executed by one or more processors, may cause the one or more processors to obtain employment information regarding the subset of employees at the company. The employment information may include a hiring rate, a promotion rate, and an attrition rate associated with the subset of employees at the company. The one or more instructions, when executed by one or more processors, may cause the one or more processors to generate an employment diversity plan associated with achieving the employment diversity goal based on the hiring rate, the promotion rate, and the attrition rate of the subset of employees at the company. The employment diversity plan may include a change to at least one of the hiring rate, the promotion rate, or the attrition rate associated with the subset of employees at the company. The one or more instructions, when executed by one or more processors, may cause the one or more processors to provide information identifying the employment diversity plan.

According to some possible implementations, a method may include determining, by a device, an employment diversity goal for a company. The employment diversity goal may be related to altering a composition of a portion of a workforce of the company. The employment diversity goal may be associated with a particular timeframe for completion. The portion of the workforce of the company may be fewer employees than the workforce of the company. The method may include determining, by the device, employment information associated with the portion of the workforce of the company. The employment information may include information associated with hiring of employees or attrition of employees. The method may include generating, by the device, a set of employment diversity plans based on the employment information. Each employment diversity plan, of the set of employment diversity plans, may be associated with achieving the employment diversity goal. The method may include selecting, by the device, a particular employment diversity plan from the set of employment diversity plans. The method may include providing, by the device, information identifying the particular employment diversity plan via a user interface.

### BRIEF DESCRIPTION OF THE DRAWINGS

FIG. 1 is a diagram of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for generating an employment diversity plan to achieve an employment diversity goal; and

FIGS. 5A-5C are diagrams of an example implementation relating to the example process shown in FIG. 4.

### DETAILED DESCRIPTION

The following detailed description of example implementations refers to the accompanying drawings. The same reference numbers in different drawings may identify the same or similar elements.

A human resources manager may establish a set of employment diversity goals to alter an employment composition of a company (e.g., to improve employment diversity at the company). For example, the human resources manager may establish an employment diversity goal of reducing a gender imbalance among managers at a company, engineers at the company, executives at the company, or the like. The human resources manager may establish a hiring plan to attempt to achieve the employment diversity goal. For example, when men outnumber women as managers at the company, the human resources manager may establish a hiring plan to increase the number of women that are hired for managerial positions, thereby reducing the gender imbalance among managers at the company.

However, establishing a hiring plan may fail to account for other factors affecting employment diversity, such as employee retention and attrition rates, an employee promotion rate, an employee recruitment rate, or the like. Implementations, described herein, may utilize employee information regarding a company to project changes to an employment composition of the company and generate an employment diversity plan to achieve an employment diversity goal. In this way, a likelihood of achieving the employment diversity goal is improved and costs associated therewith are reduced relative to establishing a hiring plan without accounting for changes to the employment composition of the company.

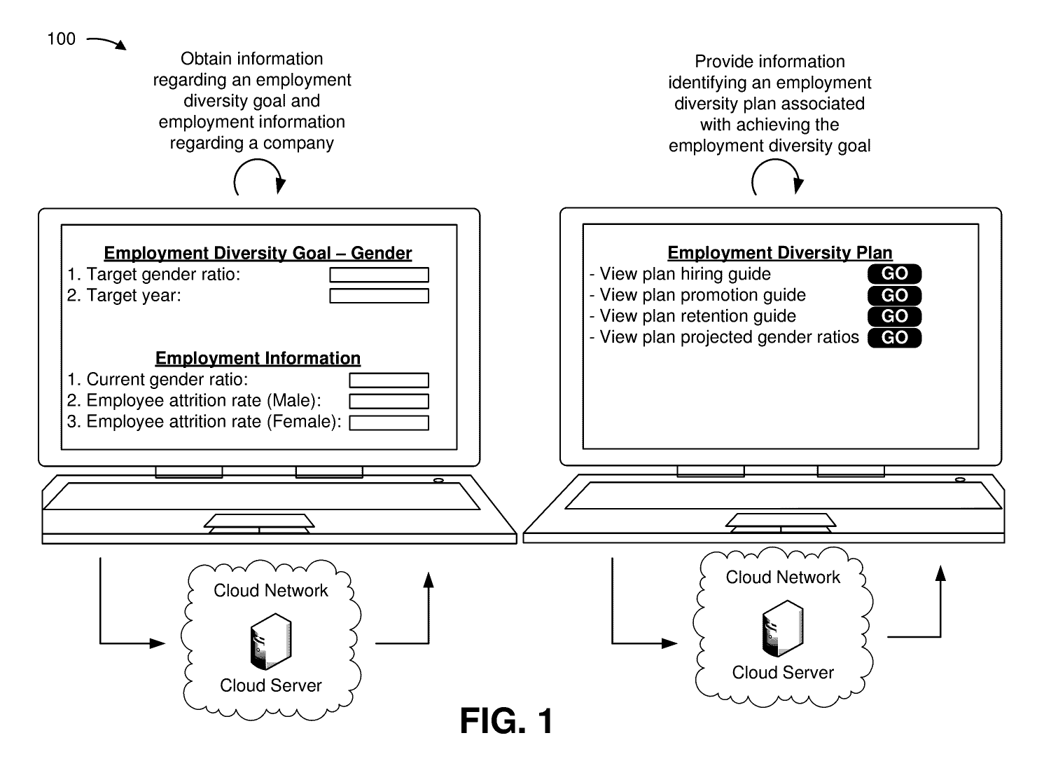

FIG. 1 is a diagram of an overview of an example implementation 100 described herein. As shown in FIG. 1, a user device may provide a user interface (e.g., based on receiving information from a cloud server) with which to input information (e.g., data) associated with generating an employment diversity plan (e.g., a recommendation). An employment diversity plan may refer to a plan for achieving an employment diversity goal, and may include a hiring plan, a promotion plan, a retention plan, an attrition plan, or the like. An employment diversity goal may relate to a goal relating to altering an employment composition of a portion of a workforce of a company, such as a goal relating to improving gender diversity, racial diversity, age diversity, ethnic diversity, or the like. For example, the user device may receive input identifying a goal of increasing a quantity of employees of a particular gender at a company, increasing a quantity of managers of a particular gender at a company, or the like.

As further shown in FIG. 1, the user device may obtain information regarding an employment diversity goal for a company. For example, the user device may receive, via the user interface, input of a target gender ratio (e.g., a 3:1 gender ratio, a 2:1 gender ratio, a 1:1 gender ratio, etc.), a target year at which to achieve the target gender ratio, or the like. In another example, the user device may receive information regarding an employment diversity goal based on the cloud server parsing a diversity statement. For example, the cloud server may receive a particular diversity statement, such as a company press release regarding diversity at the company, a multi-company agreement regarding diversity, a government regulation regarding diversity, or the like. In this case, the cloud server may parse the diversity statement (e.g., via natural language processing) to generate the employment diversity goal.

The user device may obtain employment information regarding the company. For example, the cloud server may receive, via the user device and the user interface, information identifying a current gender ratio at the company, an employee retention value (e.g., a percentage of employees that are retained each year), an employee hiring value (e.g., a quantity of new employees that are hired each year), an employee reassignment value (e.g., a percentage of employees that are reassigned from a first business unit of the company to a second business unit of the company each year), or the like.

The cloud server may identify a subset of employees to which the employment diversity goal applies, and may obtain employment information regarding the subset of employees. For example, the cloud server may determine, based on parsing the diversity statement, that the employment diversity goal applies to managerial-level employees in a particular country. In this case, the cloud server may obtain information regarding managerial-level employees in the particular country. In this way, the cloud server reduces memory usage and/or processing requirements relative to obtaining and utilizing employment information regarding all employees.

In another example, the cloud server may obtain the employment information regarding the company from a data structure. For example, the cloud server may identify a location of a data structure storing employment information, and may request and receive the employment information from the data structure. In some implementations, the cloud server may provide feedback information regarding the employment diversity goal based on the employment information. For example, the cloud server may determine, based on an employment diversity goal of another company and employment information associated with the other company, that a likelihood of achieving the employment diversity goal before the target year fails to satisfy a threshold, and may provide information identifying another target year for which the likelihood of achieving the employment diversity goal satisfies the threshold.

As further shown in FIG. 1, the cloud server may process the employment information to generate an employment diversity plan that is associated with achieving the employment diversity goal. For example, the cloud server may generate a particular employment diversity plan associated with a threshold likelihood of achieving the employment diversity goal. The particular employment diversity plan may include a set of strategies for altering the employment composition of the company to achieve the employment diversity goal. For example, when the cloud server determines that a first attrition rate for male employees exceeds a second attrition rate for female employees, the cloud server may determine that maintaining the same hiring rate for male employees and female employees will increase the quantity of female employees at the company relative to the quantity of male employees. Similarly, the cloud server may determine that a rate of promotion to managerial positions is less for female employees relative to male employees, and may provide information identifying a strategy of increasing the rate of promotion for female employees.

The cloud server may provide information identifying the employment diversity plan. For example, the cloud server may generate and provide a hiring guide (e.g., that identifies one or more changes to hiring procedures or rates to achieve a gender diversity goal, such as increasing the number of employees of a particular gender who are hired). Similarly, the cloud server may generate and provide a promotion guide (e.g., that identifies one or more changes to promotion procedures or rates to achieve the gender diversity goal, such as increasing a rate at which employees of a particular gender are promoted). Similarly, the cloud server may generate a retention guide (e.g., that identifies one or more changes to retention procedures or rates to achieve the gender diversity goal, such as increasing expenditure on programs to reduce attrition of employees of a particular gender, increasing salaries of employees of the particular gender, or the like). The cloud server may provide information identifying a projected change to an employment composition over time. For example, the cloud server may provide information identifying projected gender ratios based on implementing the employment diversity plan.

In another example, the cloud server may automatically generate a company policy associated with the employment diversity plan and relating to achieving the employment diversity goal, an incentive plan associated with the employment diversity plan (e.g., for compensating employees to alter an attrition rate and achieve the employment diversity goal), or the like. In another example, the cloud server may automatically track progress of the employment diversity plan, identify one or more relevant stakeholders and generate associated action items or calendar entries for the one or more relevant stakeholders (e.g., relating to project milestones, progress meetings, etc.), or the like. In another example, the cloud server may automatically generate and post a set of employment advertisements relating to the employment diversity plan (e.g., an advertisement for employees of a particular gender to achieve a gender-based employment diversity goal or the like). Similarly, the cloud server may automatically obtain information regarding and/or contact a particular type of candidate, such as by contacting a representative of an all-women's university, a historically black college, a chapter of the society of women engineers, a chapter of the national society of black engineers, or the like.

In this way, a cloud server may automatically provide an employment diversity plan and/or information associated therewith to achieve an employment diversity goal, thereby facilitating improved management of employment diversity for a company. Furthermore, the cloud server may increase a likelihood of achieving an employment diversity goal relative to generating a hiring plan without accounting for factors other than a current employment diversity or hiring rate. For example, when the cloud server determines that a first retention rate for female employees is higher than a second retention rate for male employees, the cloud server may determine that the difference between the first retention rate and the second retention rate is projected to reduce the gender imbalance before the target year, thereby obviating the need for any expenditures to alter hiring practices. Moreover, based on providing granularity in identifying a subset of employees to which the employment diversity goal applies (e.g., managerial employees, North American employees, etc.), the cloud server reduces memory and/or processing requirements relative to analyzing employment information regarding all employees of a company.

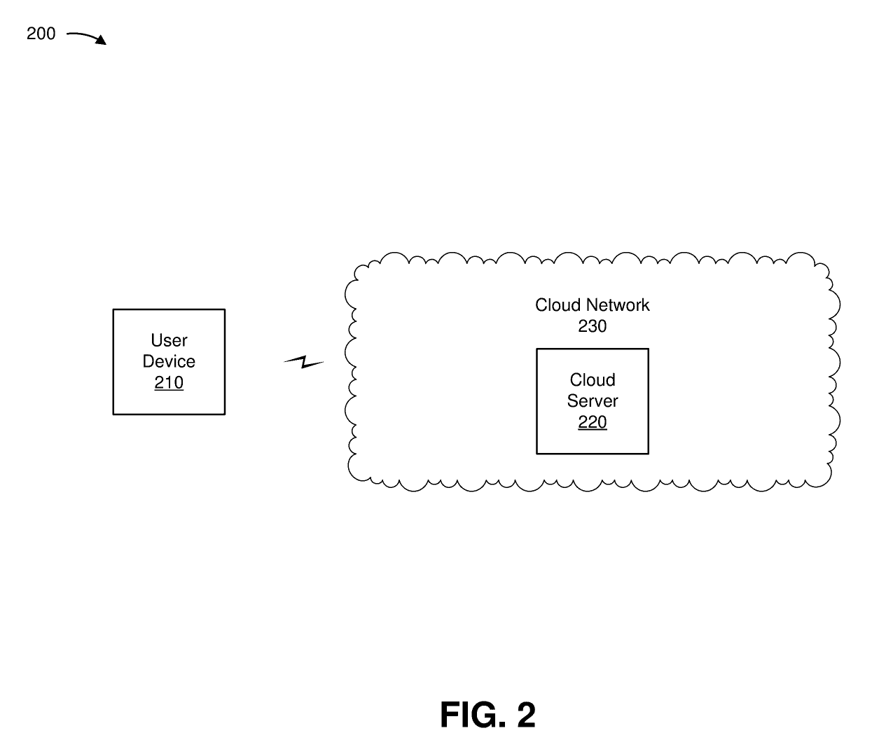

FIG. 2 is a diagram of an example environment 200 in which systems and/or methods, described herein, may be implemented. As shown in FIG. 2, environment 200 may include a user device 210, a cloud server 220, and a cloud network 230. Devices of environment 200 may interconnect via wired connections, wireless connections, or a combination of wired and wireless connections.

User device 210 may include one or more devices capable of receiving, generating, storing, processing, and/or providing information associated with an employment diversity plan. For example, user device 210 may include a communication and/or computing device, such as a mobile phone (e.g., a smart phone, a radiotelephone, etc.), a computer (e.g., a laptop computer, a tablet computer, a handheld computer, a desktop computer, etc.), a wearable communication device (e.g., a smart wristwatch, a pair of smart eyeglasses, etc.), or a similar type of device. In some implementations, user device 210 may provide a user interface with which to input information regarding an employment diversity goal and/or employment information regarding a company. In some implementations, user device 210 may receive information from and/or transmit information to another device in environment 200.

Cloud server 220 may include one or more devices capable of storing, processing, and/or routing information associated with an employment diversity plan. For example, cloud server 220 may include a server that generates an employment diversity plan associated with achieving an employment diversity goal based on employment information regarding a company. In some implementations, cloud server 220 may include stored information regarding a set of other companies, and may process the stored information to generate the employment diversity plan and/or determine a likelihood that the employment diversity plan achieves the employment diversity goal within a target timeframe for completion of the employment diversity goal. In some implementations, cloud server 220 may include a communication interface that allows cloud server 220 to receive information from and/or transmit information to other devices in environment 200. While cloud server 220 will be described as a resource in a cloud computing network, such as cloud network 230, cloud server 220 may operate external to a cloud computing network, in some implementations.

Cloud network 230 may include an environment that delivers computing as a service, whereby shared resources, services, etc. may be provided by cloud server 220 to store, process, and/or route information associated with an employment diversity plan. Cloud network 230 may provide computation, software, data access, storage, and/or other services that do not require end-user knowledge of a physical location and configuration of a system and/or a device that delivers the services (e.g., cloud server 220). As shown, cloud network 230 may include cloud server 220 and/or may communicate with user device 210 via one or more wired or wireless networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. For example, although user device 210 and cloud server 220 are shown as two separate devices, user device 210 and cloud server 220 may be implemented within a single device. Additionally, or alternatively, a set of devices (e.g., one or more devices) of environment 200 may perform one or more functions described as being performed by another set of devices of environment 200.

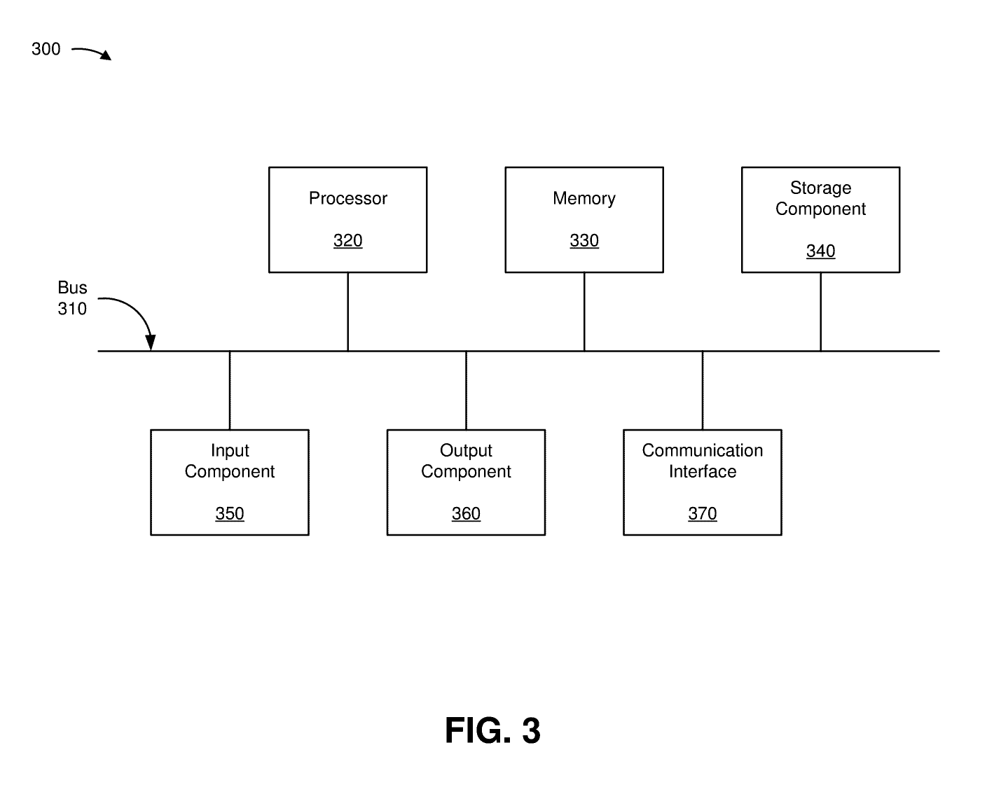

FIG. 3 is a diagram of example components of a device 300. Device 300 may correspond to user device 210 and/or cloud server 220. In some implementations, user device 210 and/or cloud server 220 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 is implemented in hardware, firmware, or a combination of hardware and software. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. In some implementations, processor 320 may include one or more processors that can be programmed to perform a function. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

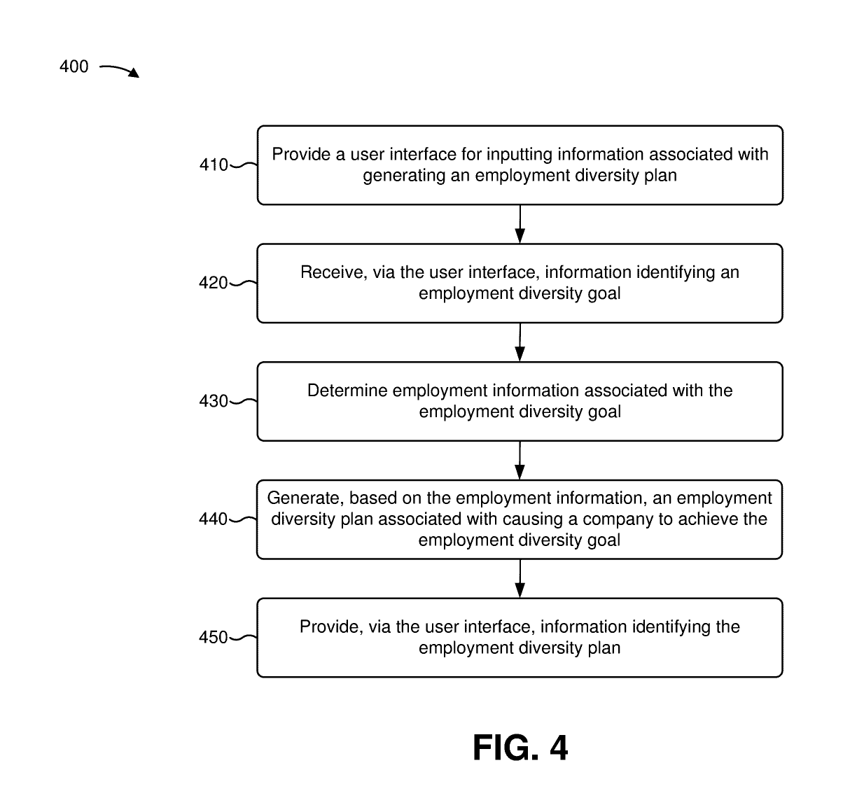

FIG. 4 is a flow chart of an example process 400 for generating an employment diversity plan to achieve an employment diversity goal. In some implementations, one or more process blocks of FIG. 4 may be performed by cloud server 220. In some implementations, one or more process blocks of FIG. 4 may be performed by another device or a group of devices separate from or including cloud server 220, such as user device 210.

As shown in FIG. 4, process 400 may include providing a user interface for inputting information associated with generating an employment diversity plan (block 410). For example, cloud server 220 may provide, via user device 210, the user interface for inputting the information associated with generating the employment diversity plan. In some implementations, cloud server 220 may generate the user interface based on a type of employment diversity goal. For example, when an employment diversity goal, which is to be achieved by an employment diversity plan, relates to gender diversity, cloud server 220 may generate a particular user interface for receiving information associated with generating an employment diversity plan associated with gender diversity, such as a hiring rate for male employees, a hiring rate for female employees, or the like.

As further shown in FIG. 4, process 400 may include receiving, via the user interface, information identifying an employment diversity goal (block 420). For example, cloud server 220 may receive, via the user interface and user device 210, information identifying the employment diversity goal for a company. In some implementations, cloud server 220 may obtain information identifying a type of employment diversity goal. For example, cloud server 220 may receive, via the user interface, information identifying a gender-based employment diversity goal, an age-based employment diversity goal, a race-based employment diversity goal, an ethnicity-based employment diversity goal, or the like. In some implementations, cloud server 220 may receive information identifying types of employees associated with the employment diversity goal (e.g., employment positions to which the employment diversity goal applies). For example, cloud server 220 may receive information indicating that the employment diversity goal relates to all employees at a company, managers at a company, engineers at a company, new employees at a company, promoted employees at a company, consultants hired by a company, subcontractors contracted with by the company, employees of a particular seniority at the company, employees lacking a particular level of seniority at the company, or the like.

In some implementations, cloud server 220 may generate the employment diversity goal. For example, cloud server 220 may receive information identifying a diversity statement, such as a company press release, a multi-company agreement to which the company is a party, a government regulation that is associated with employment diversity, or the like. In this case, cloud server 220 may process the information identifying the diversity statement to generate an employment diversity goal, such as by utilizing a natural language processing technique, identifying data in the diversity statement (e.g., numerical data, such as a percentage relating to diversity), or the like. Additionally, or alternatively, cloud server 220 may receive employment information regarding the company and/or one or more other companies. In this case, cloud server 220 may select the employment diversity goal for the company based on the employment information regarding the company. For example, cloud server 220 may identify a gender imbalance among managers of the company, and may set an employment diversity goal of reducing the gender imbalance. In this way, cloud server 220 reduces computing utilization by obviating the need for a human resources manager to identify or select the employment diversity goal.

In some implementations, cloud server 220 may receive information identifying an employment location associated with the employment diversity goal. For example, cloud server 220 may determine that the employment diversity goal is to apply to employees located on a particular continent, in a particular country, at a particular company facility, or the like. In this case, cloud server 220 may identify a subset of employees of the set of employees of the company to which the employment diversity goal is to apply, and may obtain and utilize employee information regarding the subset of employees rather than the set of employees. In this way, cloud server 220 reduces computing utilization and/or memory requirements relative to obtaining and utilizing employee information regarding the set of employees.

In some implementations, cloud server 220 may receive information identifying a timeline for achieving the diversity goal. For example, cloud server 220 may determine that a user intends cloud server 220 to generate an employment diversity plan for achieving the employment diversity goal in a particular quantity of years. In some implementations, cloud server 220 may determine that the employment diversity goal is intended to be open-ended. For example, cloud server 220 may determine that the employment diversity plan is intended to be implemented on a permanent basis, a semi-permanent basis, or the like, without a particular time interval with which to achieve the employment diversity goal.

In some implementations, cloud server 220 may provide feedback information indicating a feasibility of the employment diversity goal. For example, cloud server 220 may determine that one or more other companies with similar employment information implemented similar employment diversity goals. In this case, cloud server 220 may determine a likelihood of the company achieving the employment diversity goal based on whether the one or more other companies achieved the similar employment diversity goals, and may provide feedback based on the likelihood of the company achieving the employment diversity goal.

In some implementations, cloud server 220 may determine (e.g., using a machine learning technique, a pattern recognition technique, an artificial intelligence technique, etc.) whether the likelihood of achieving the employment diversity goal fails to satisfy a threshold likelihood based on information associated with the one or more other companies (e.g., employment information, information identifying a set of employment diversity plans that have been implemented, etc.). For example, cloud server 220 may determine that a 5% probability is associated with achieving the employment diversity goal during a 3-year period and that an 85% probability is associated with achieving the same employment diversity goal during a 5-year period based on applying a pattern matching technique to information indicating that a set of similar companies achieved a similar employment diversity goal over an approximately 5-year period. In this case, cloud server 220 may provide feedback information suggesting setting a 5-year period for the employment diversity plan to achieve the employment diversity goal.

In some implementations, cloud server 220 may provide feedback information associated with a cost of achieving the employment diversity goal. For example, cloud server 220 may determine that a cost associated with achieving the employment diversity goal during the 3-year period exceeds a threshold cost based on applying a pattern matching technique to costs associated with implementing an employment diversity plan to achieve a similar employment diversity goal at another company, and may provide feedback information recommending the 5-year period based on a cost associated with the 5-year period not being projected to exceed the threshold cost.

As further shown in FIG. 4, process 400 may include determining employment information associated with the employment diversity goal (block 430). For example, cloud server 220 may obtain, via the user interface and user device 210, employment information associated with the employment diversity goal, such as information relating to employment at a company associated with the employment diversity goal. Additionally, or alternatively, cloud server 220 may obtain employment information from a data structure, such as from a data structure associated with storing information regarding employees, evaluations of employees, company financial information, or the like. For example, cloud server 220 may determine a gender ratio at the company, an employee retention rate at the company, a new employee hiring rate at the company, an employee attrition rate at the company, an employee promotion rate at the company, or the like.

In some implementations, cloud server 220 may obtain employment information including one or more projections regarding employment at the company. For example, cloud server 220 may prompt a user, via the user interface, to provide information identifying a projected hiring rate, a projected company growth rate, or the like. Additionally, or alternatively, cloud server 220 may determine a projected employment composition of the company, such as a projected gender ratio of employees at the company (e.g., based on a hiring rate of men and women at the company, a promotion rate of men and women at the company, an attrition rate of men and women at the company, or the like).

In some implementations, cloud server 220 may obtain employment information regarding one or more other companies. For example, cloud server 220 may determine that the employment diversity goal satisfies a threshold similarity with another employment diversity goal associated with another company, and may obtain information regarding employees of the other company, changes to employment diversity at the other company based on implementing an employment diversity plan at the other company, or the like. In this way, cloud server 220 obtains information that can be utilized to identify strategies that may cause the company to achieve the employment diversity goal.

As further shown in FIG. 4, process 400 may include generating, based on the employment information, an employment diversity plan associated with causing a company to achieve the employment diversity goal (block 440). For example, cloud server 220 may generate the employment diversity plan with a set of strategies to cause the company to satisfy the employment diversity goal. In some implementations, cloud server 220 may generate one or more projections based on the employment information. For example, when an employment diversity goal relates to gender diversity, such as improving a gender mix ratio (e.g., a ratio of employees of a particular gender to total employees), cloud server 220 may project a change to the gender mix ratio at the company based on an alteration to a hiring rate, an attrition rate, or the like. In this way, cloud server 220 determines whether modifying a hiring rate, an attrition rate, or the like causes the company to satisfy the employment diversity goal.

In some implementations, cloud server 220 may identify and/or select one or more strategies for the employment diversity plan that are associated with causing the company to achieve the employment diversity goal. For example, cloud server 220 may determine that a particular percentage increase to a hiring rate of female employees causes the company to achieve the employment diversity goal within a particular period of time. In this case, cloud server 220 may select a hiring strategy for increasing the hiring rate of female employees by the particular percentage, such as sending targeted employment applications to potential female employees or the like. Similarly, cloud server 220 may select another hiring strategy, such as implementing a training program to reduce a bias against female employment candidates during employment interviews. In this way, cloud server 220 identifies one or more strategies that, when implemented by a company, cause the company to achieve an employment diversity goal.

In some implementations, cloud server 220 may select a strategy for the employment diversity plan associated with altering an employee retention rate of a particular set of employees. For example, cloud server 220 may determine that reducing an attrition rate of employees over 40 causes the company to satisfy the set of employment diversity goals relating to age diversity. In this case, cloud server 220 may select a retention strategy of offering remote working opportunities to employees over 40 to reduce a likelihood of attrition by retirement. Similarly, when the employment diversity goal relates to increasing a quantity of female employees at the company, cloud server 220 may select a strategy of targeting female employees for a bonus program, thereby improving a retention rate for female employees, which, in combination with hiring of female employees, increases the quantity of female employees at the company.

In some implementations, cloud server 220 may select a strategy associated with altering an employee promotion rate to achieve an employment diversity goal. For example, cloud server 220 may determine that internal promotion of managers corresponds to a reduced gender imbalance at the company and that lateral hiring of managers (from other companies) corresponds to an increased gender imbalance at the company. In this case, cloud server 220 may select a strategy that causes increased internal promotion of managers relative to lateral hiring of managers, such as favorable interview schedules, internal hiring bonuses, or the like.

In some implementations, cloud server 220 may select a strategy based on information included in a repository of strategies for employment diversity plans. For example, cloud server 220 may obtain information regarding employment diversity plans implemented at the company, at other companies, or the like, and may categorize strategies utilized therein based on an effect on an employment composition. In this case, cloud server 220 may utilize a machine learning technique, a heuristic technique, a pattern recognition technique, an artificial intelligence technique, or the like to identify a required effect on an employment composition of the company to achieve the employment diversity goal, and may select a strategy, from the repository of strategies, associated with the required effect.

In some implementations, cloud server 220 may select multiple strategies (e.g., actions of the employment diversity plan), such as a hiring strategy, a retention strategy, a promotion strategy, or the like. For example, cloud server 220 may apply a machine learning technique or the like to the employment information to identify a combination of multiple strategies that are projected to achieve the employment diversity goal. As an example, when attempting to increase a quantity of female managers at a company, cloud server 220 may determine that a promotion strategy (e.g., promoting female employees at a higher rate than was previously achieved) is associated with a first increase to a quantity of female managers, that a retention strategy (e.g., retaining female employees at a higher rate than was previously achieved) is associated with a second increase to the quantity of female managers, and that a recruiting strategy (e.g., recruiting lateral hires of female managers and recruiting entry-level female employees for subsequent promotion to manager) is associated with a third increase to the quantity of female managers. In this case, cloud server 220 may determine a cost associated with each of the strategies and may optimize an extent to which each strategy is utilized to reduce cost (e.g., a particular promotion rate increase causing a first cost in man-hours to implement, a particular retention rate increase causing a second cost in man-hours to implement, etc.). In this way, cloud server 220 may reduce costs by optimizing utilizing of multiple strategies.

In some implementations, cloud server 220 may generate multiple employment diversity plans, each of which satisfies the employment diversity goal, based on the employment information. For example, cloud server 220 may process the employment information to generate multiple employment diversity plans that include multiple sets of strategies (e.g., hiring strategies, retention and attrition strategies, promotion strategies, a combination of multiple different types of strategies, or the like). In this case, cloud server 220 may generate a score for each employment diversity plan based on a set of criteria, such as a likelihood that a particular employment diversity plan achieves the employment diversity goal, a quantity of time that is expected to elapse before the particular employment diversity plan achieves the employment diversity goal, how many employment diversity goals of a set of multiple employment diversity goals achieved, or the like.

As an example, cloud server 220 may apply a set of weights to the set of factors, such as a first weight to a percentage of the employment diversity goal that is achieved within a target period of time, a second weight to a cost of implementing the employment diversity goal, a third weight to a projected employee satisfaction with the employment diversity plan, or the like, and may determine that a score for a first employment diversity plan exceeds a score for a second employment diversity plan based on applying the set of weights to the set of factors. In some implementations, cloud server 220 may select the employment diversity plan based on a score. For example, cloud server 220 may select a particular employment diversity plan that is associated with a higher score than other employment diversity plans. Additionally, or alternatively, cloud server 220 may select multiple employment diversity plans that satisfy a score threshold, and may provide information identifying the multiple employment diversity plans for user selection.

In some implementations, cloud server 220 may generate the score for the set of employment diversity plans based on information associated with one more other companies. For example, when cloud server 220 is associated with a group of companies, cloud server 220 may obtain satisfaction scores for similar employment diversity plans implemented by the one or more companies, and may select a particular employment diversity plan from the set of employment diversity plans based on a satisfaction score for a similar employment diversity plan associated with another company. Additionally, or alternatively, cloud server 220 may utilize other information associated with the other companies, such as information identifying a likelihood of achieving an employment diversity plan, information identifying a timeframe for achieving an employment diversity plan, or the like, when generating a score for an employment diversity plan.

Additionally, or alternatively, cloud server 220 may determine a cost metric associated with the employment diversity plan. For example, cloud server 220 may determine a cost associated with implementing a set of strategies included in the employment diversity plan based on a quantity of man-hours that are required to implement the set of strategies, an amount of money required to pay for costs associated with the set of strategies (e.g., advertising costs, travel reimbursements for interview candidates, fees paid to job listing websites, etc.), or the like. In some implementations, cloud server 220 may determine the cost metric based on information associated with one or more other companies. For example, cloud server 220 may determine that another company implementing a similar employment diversity plan incurred a particular cost in implementing the similar employment diversity plan, and may utilize machine learning, pattern recognition, or the like to estimate a cost to the company based on the particular cost to the other company. In some implementations, cloud server 220 may select the employment diversity plan from a set of employment diversity plans based on the cost associated with implementing the employment diversity plan. For example, cloud server 220 may select a particular employment diversity plan with the lowest cost, multiple employment diversity plans with respective costs that are less than a threshold, or the like.

As further shown in FIG. 4, process 400 may include providing, via the user interface, information identifying the employment diversity plan (block 450). For example, cloud server 220 may provide, via the user interface and user device 210, information identifying the employment diversity plan. In some implementations, cloud server 220 may provide information identifying one or more strategies of the employment diversity plan. For example, cloud server 220 may provide information identifying a hiring strategy, a promotion strategy, an employee retention strategy, an attrition strategy, or the like. In this case, cloud server 220 may provide information identifying a cost associated with each strategy (e.g., a projected cost determined utilizing on a machine learning technique or the like based on information associated with one or more other companies implementing one or more similar strategies). In some implementations, cloud server 220 may provide a projection relating to implementing the employment diversity plan. For example, cloud server 220 may provide information identifying a projected change to employment at the company (e.g., a change to a gender mix ratio of the company, a change to an average age of the company, or the like) based on implementing one or more strategies of the employment diversity plan.

In some implementations, cloud server 220 may provide updated projections based on receiving input via the user interface. For example, cloud server 220 may provide information identifying a target hiring rate to satisfy the employment diversity goal, and a user may provide input associated with altering the target hiring rate (e.g., increasing the target hiring rate, reducing the target hiring rate, etc.). In this case, cloud server 220 may alter projections based on altering the target hiring rate, such as a projection indicating that the employment diversity goal is achieved based on altering the target hiring rate, a projection indicating that the employment diversity goal is not achieved based on altering the target hiring rate, or the like.

In some implementations, cloud server 220 may generate a new employment diversity plan based on receiving user input. For example, when cloud server 220 receives an alteration to a hiring rate associated with a first employment diversity plan, cloud server 220 may generate a second employment diversity plan that is associated with achieving the set of employment diversity goals. In this way, cloud server 220 dynamically updates the employment diversity plan based on user interaction.

In some implementations, cloud server 220 may provide information identifying the employment diversity plan to one or more stakeholders. For example, based on the set of strategies included in the employment diversity plan, cloud server 220 may automatically categorize parts of the employment diversity plan based on employees that are associated with implementing the parts of the employment diversity plan (e.g., a hiring manager for a hiring part, a recruitment manager of a recruitment part, etc.). In this case, cloud server 220 may automatically provide information identifying respective parts of the employment diversity plan to respective employees, such as by providing action item notifications, generating calendar entries (e.g., and populating calendar entries to calendars), scheduling progress meetings, or the like. In this way, cloud server 220 automatically disseminates the employment diversity plan to cause the company to achieve the employment diversity goal.

In some implementations, cloud server 220 may automatically generate a set of company policies. For example, cloud server 220 may alter a company data structure storing company policies, an employment handbook, or the like to include one or more company policies associated with the employment diversity plan, such as including information identifying a new employee compensation scheme, information identifying new promotion opportunities, or the like.

In some implementations, cloud server 220 may automatically generate an incentive plan for employees of the company. For example, when cloud server 220 selects an employment diversity plan that includes bonuses for employees at the company who recruit new employees to achieve the employment diversity goal, cloud server 220 may provide information identifying the bonuses that the employees can receive, thereby increasing a likelihood that employees utilize benefits provided under the employment diversity plan and increasing a likelihood that the employment diversity plan is successful in achieving the employment diversity goal.

In some implementations, cloud server 220 may automatically track progress associated with implementing the employment diversity plan. For example, cloud server 220 may provide periodic updates identifying a progress of the employment diversity plan at altering the composition of employees at the company. In some implementations, cloud server 220 may identify a threshold deviation from a projection associated with the employment diversity plan. For example, cloud server 220 may determine that an increase to a hiring rate of female employees has not occurred within a particular period of time, and may generate an altered employment diversity plan to account for the lack of the increase to the hiring rate of female employees, thereby increasing a likelihood that the employment diversity goal is achieved relative to statically implementing the employment diversity plan.

In some implementations, cloud server 220 may automatically implement the employment diversity plan. For example, when the employment diversity plan includes a plan of increasing on-campus recruiting of female engineers, cloud server 220 may automatically identify a set of recruitment candidate locations, such as one or more all-women's colleges, one or more historically black colleges and universities, one or more chapters of the society of women engineers, one or more chapters of the national society of black engineers, or the like, and may automatically generate messages to the set of recruitment candidate locations to recruit engineers from the set of recruitment candidate locations. Similarly, cloud server 220 may automatically post job opportunities to a set of online job boards, such as by utilizing an application programming interface (API) of a particular online job board to automatically generate a post.

In some implementations, cloud server 220 may automatically generate information announcing the employment diversity plan. For example, cloud server 220 may utilize an automatic news article generation algorithm to generate a press release indicating that the company is implementing the employment diversity plan. In this way, cloud server 220 automatically publicizes the employment diversity plan.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

In this way, cloud server 220 reduces computing resources required to generate an employment diversity plan based on filtering employment information to utilize information regarding a subset of employees to whom the employment diversity goal applies. Moreover, based on efficiently and automatically administering the employment diversity plan (e.g., based on automatically monitoring progress, automatically providing information to relevant stakeholders, etc.), cloud server 220 reduces computing resource utilization (e.g., a quantity of messages transmitted, a quantity of processing performed, etc.) relative to a human administering an employment diversity plan for a large, complex company.

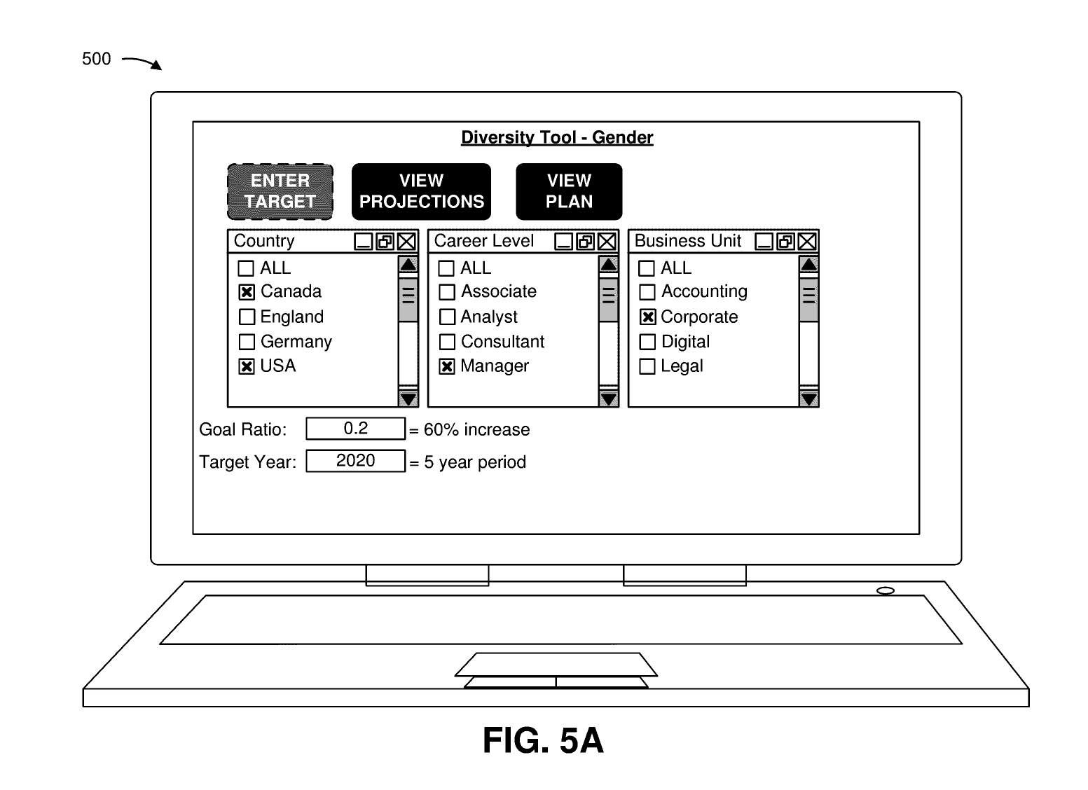

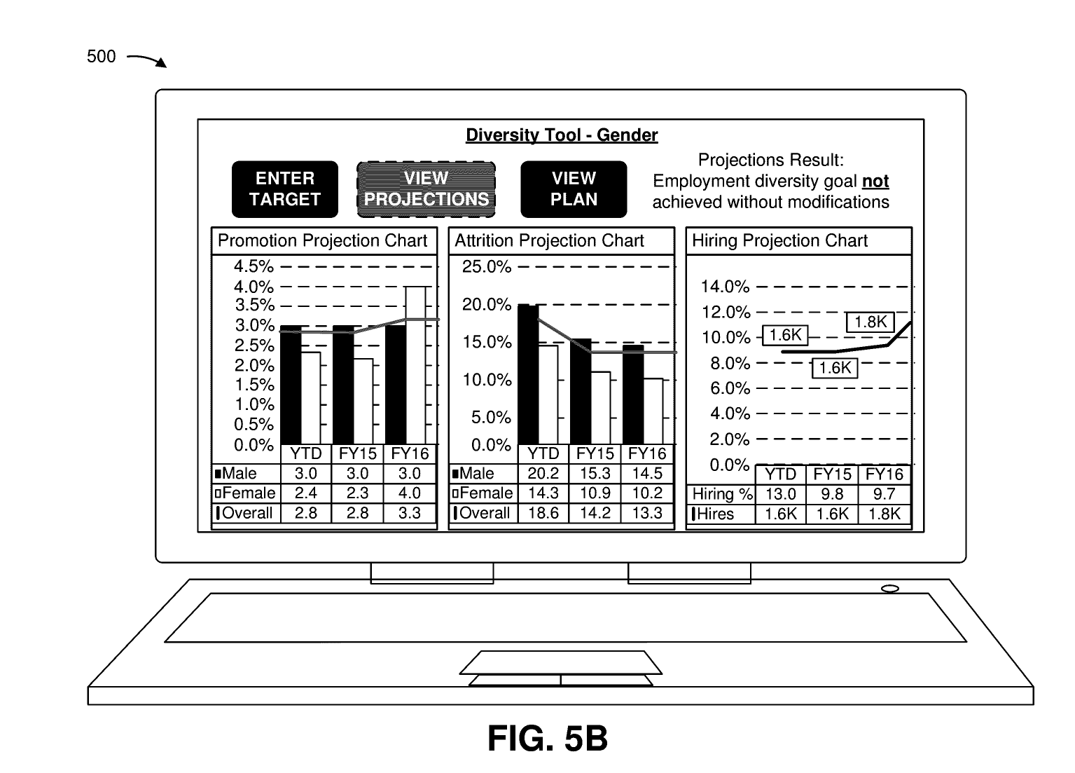

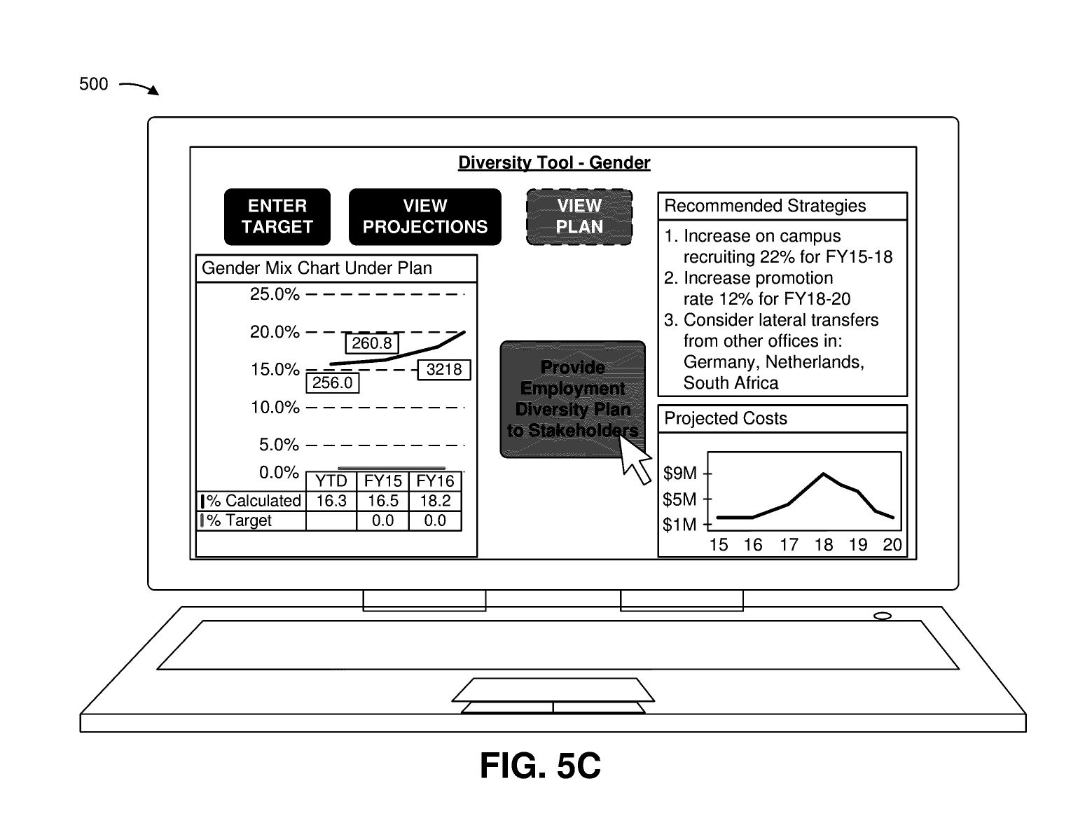

FIGS. 5A-5C are diagrams of an example implementation 500 relating to example process 400 shown in FIG. 4. FIGS. 5A-5C show an example of generating an employment diversity plan to achieve an employment diversity goal.

As shown in FIG. 5A, cloud server 220 causes user device 210 to display a user interface facilitating input of information associated with generating an employment diversity plan. Assume that a user inputs information identifying an employment diversity goal (e.g., a gender diversity ratio of 0.2, indicating a 60% increase in female employees at a company) and a target year associated with the employment diversity goal (e.g., “2020,” indicating a 5 year period for the employment diversity plan). Further assume that the user inputs employment information identifying to which employees the employment diversity goal applies, such as a set of common geographic areas (e.g., employees located in Canada, USA, etc.), a set of common employment statuses (e.g., employees who are managers), a set of common business units (e.g., employees assigned to the “corporate” business unit), or the like. In this way, cloud server 220 provides a user interface that permits a user to provide information describing an employment diversity goal for a company. Moreover, cloud server 220 provides a user interface that permits a user to selectively filter data to cause cloud server 220 to process data relating to employees associated with the employment diversity goal (e.g., managers located in Canada, USA, etc.), rather than process all data associated with the company, thereby reducing processing and/or memory utilization. Assume that cloud server 220 obtains employment information and generates a set of projections relating to the employment information (e.g., based on applying a machine learning technique to data relating to managers located in Canada, USA, etc.).

As shown in FIG. 5B, cloud server 220 causes user device 210 to display a user interface identifying the employment information and a set of projections associated with the employment information. The user interface provides information indicating that based on employment information associated with the company and a set of projections, the employment diversity goal is not achieved without modification of one or more parameters (e.g., a hiring rate, an attrition rate, etc.).

As shown in FIG. 5C, cloud server 220 generates an employment diversity plan and provides the employment diversity plan for display via the user interface and user device 210. The employment diversity plan includes information identifying a projected gender mix (e.g., a comparison of respective quantities of female employees and male employees to whom the employment diversity goal is intended to apply). The employment diversity plan includes information identifying a set of recommended strategies associated with the employment diversity plan, such as an increase to a campus recruiting during a particular set of years, an increase to a promotion rate during another particular set of years, an increase to internal transfers between offices. User device 210 provides, for display, projected costs associated with implementing the employment diversity plan. Based on user interaction with a button, user device 210 provides information identifying the employment diversity plan to relevant stakeholders, such as campus recruiting managers, promotion managers, lateral transfer managers, or the like.

As indicated above, FIGS. 5A-5C are provided merely as an example. Other examples are possible and may differ from what was described with regard to FIGS. 5A-5C.

In this way, cloud server 220 generates an employment diversity plan that is associated with causing the company to achieve an employment diversity goal. Moreover, cloud server 220 includes information regarding hiring rates, promotion rates, retention and attrition rates, or the like when generating the employment diversity plan, thereby better accounting for alterations to the composition of employment at a company relative to accounting for only a hiring rate. In this way, cloud server 220 increases a likelihood that the employment diversity plan achieves the employment diversity goal within a target period of time, thereby reducing cost, time, or the like.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

To the extent the aforementioned implementations are utilized to influence employment outcomes, it should be understood that such information shall be used in accordance with all applicable laws concerning non-discrimination of employees. Accordingly, it may be appropriate to modify an employment diversity plan to ensure that there is no discrimination on the basis of race, color, national or ethnic origin, ancestry, age, religion or religious creed, disability or handicap, sex or gender, gender identity, sexual orientation, military or veteran status, genetic information, or any other characteristic protected under applicable law. Moreover, although implementations are described herein in terms of diversity goals relating to certain characteristics, other non-diversity related employment goals may be equally applicable, such as a goal relating to employee education level, a goal relating to employee performance ratings, or the like.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
receive data from a user,
automatically evaluate the data to generate a set of recommendations, where each of the recommendations relates to a recommended action to be taken by the user,
select a recommendation from the set of recommendations based on a set of decision criteria,
the set of decision criteria relating to a feasibility of implementing the recommendation;
identify a plurality of users to implement the recommendation selected from the set of recommendations; and
provide, to each respective user of the plurality of users, respective information identifying a respective portion of the recommendation that is to be implemented by the respective user.

2. The device of claim 1, where the set of recommendations are a set of employment diversity plans and the recommendation is a particular employment diversity plan of the set of employment diversity plans, and where the one or more processors are further to:
determine a set of scores corresponding to the set of employment diversity plans based on a set of costs associated with the set of employment diversity plans,
the particular employment diversity plan being associated with a particular cost that is less than other costs of the set of costs; and
where the one or more processors, when selecting the recommendation from the set of recommendations based on the set of decision criteria, are to:
select the particular employment diversity plan from the set of employment diversity plans based on the set of scores.

3. The device of claim 1, where the set of recommendations are a set of employment diversity plans and the recommendation is a particular employment diversity plan of the set of employment diversity plans, and where the one or more processors are further to:
determine a set of scores corresponding to the set of employment diversity plans based on a set of projected quantities of time for achieving the employment diversity goal associated with the set of employment diversity plans,
the particular employment diversity plan being associated with a particular projected quantity of time less than other projected quantities of time of the set of projected quantities of time; and
where the one or more processors, when selecting the recommendation from the set of recommendations based on the set of decision criteria, are to:
select the particular employment diversity plan based on the set of projected quantities of time.

4. The device of claim 3, where the one or more processors, when generating the set of recommendations, are to:
generate the set of recommendations based on a set of projections relating to the change to a composition of a set of employees of a company,
the set of projections being generated based on at least one of:
a machine learning technique,
a pattern matching technique,
an artificial intelligence technique, or
a heuristic technique.

5. The device of claim 1, where the one or more processors, when receiving data from the user, are further to:
receive, via the user interface, information identifying a common geographic location, a common employment status, or a common business unit associated with a set of employees of a company; and
identify the set of employees based on the information identifying the common geographic location, the common employment status, or the common business unit associated with the set of employees; and
where the one or more processors, when automatically evaluating the data, are to:
automatically evaluate a portion of the data relating to the set of employees.

6. The device of claim 1, where the one or more processors are further to:
identify a set of milestones associated with the recommendation;
generate a set of calendar entries associated with the set of milestones; and
automatically populate the set of calendar entries to one or more calendars associated with one or more stakeholders based on generating the set of calendar entries associated with the set of milestones.

7. The device of claim 1, where the recommendation is associated with achieving at least one of:
a gender-based employment diversity goal,
a race-based employment diversity goal,
an age-based employment diversity goal, or
an ethnicity-based employment diversity goal.

8. A non-transitory computer-readable medium storing instructions, the instructions comprising:
one or more instructions that, when executed by one or more processors, cause the one or more processors to:
receive information identifying an employment diversity goal for a company,
the employment diversity goal being related to improving diversity among a group of employees at the company,
the group of employees being a subset of employees at the company that have a common geographic location, that have a common employment status, or that work for a common business unit;
obtain employment information regarding the subset of employees at the company,
the employment information including a hiring rate, a promotion rate, and an attrition rate associated with the subset of employees at the company;
generate an employment diversity plan associated with achieving the employment diversity goal based on the hiring rate, the promotion rate, and the attrition rate of the subset of employees at the company,
the employment diversity plan including a change to at least one of the hiring rate, the promotion rate, or the attrition rate associated with the subset of employees at the company; and
provide information identifying the employment diversity plan.

9. The computer-readable medium of claim 8, where the one or more instructions, when executed by the one or more processors, further cause the one or more processors to:
determine a projected employment composition of the subset of employees at the company based on the hiring rate, the promotion rate, and the attrition rate associated with the subset of employees at the company;
determine that the projected employment composition does not achieve the employment diversity goal,
the employment diversity goal relating to gender diversity; and
where the one or more instructions, that cause the one or more processors to generate the employment diversity plan, further cause the one or more processors to:
generate the employment diversity plan to improve gender diversity based on determining that the projected employment composition does not achieve the employment diversity goal.

10. The computer-readable medium of claim 8, where the one or more instructions, that cause the one or more processors to provide the information identifying the employment diversity plan, cause the one or more processors to:
provide the information identifying the employment diversity plan via a user interface.

11. The computer-readable medium of claim 8, where the one or more instructions, that cause the one or more processors to provide the information identifying the employment diversity plan, cause the one or more processors to:
identify a set of stakeholders associated with implementing the employment diversity plan;
determine that a particular stakeholder, of the set of stakeholders, is associated with implementing a particular portion of the employment diversity plan; and
provide the information, to the particular stakeholder, identifying the particular portion of the employment diversity plan.

12. The computer-readable medium of claim 8, where the one or more instructions, when executed by the one or more processors, further cause the one or more processors to:
determine that a particular change to the hiring rate is associated with causing the company to achieve the employment diversity goal within a target period of time; and
where the one or more instructions, that cause the one or more processors to generate the employment diversity plan, cause the one or more processors to:
include the particular change to the hiring rate in the employment diversity plan.

13. The computer-readable medium of claim 8, where the one or more instructions, that cause the one or more processors to generate the employment diversity plan, further cause the one or more processors to:
determine a set of strategies associated with causing the change to the at least one of the hiring rate, the promotion rate, or the attrition rate of the subset of employees at the company; and
include information identifying the set of strategies in the employment diversity plan.

14. The computer-readable medium of claim 8, where the one or more instructions, when executed by the one or more processors, are further to:
obtain other employment information regarding one or more other companies;
obtain information regarding one or more other employment diversity plans implemented at the one or more other companies; and
where the one or more instructions, that cause the one or more processors to generate the employment diversity plan, cause the one or more processors to:
generate the employment diversity plan based on the other employment information and the information regarding the one or more other employment diversity plans.

15. A method, comprising:
determining, by a device, an employment diversity goal for a company,
the employment diversity goal being related to altering a composition of a portion of a workforce of the company,
the employment diversity goal being associated with a particular timeframe for completion,
the portion of the workforce of the company being fewer employees than the workforce of the company;
determining, by the device, employment information associated with the portion of the workforce of the company,
the employment information including information associated with hiring of employees or attrition of employees;
generating, by the device, a set of employment diversity plans based on the employment information,
each employment diversity plan, of the set of employment diversity plans, being associated with achieving the employment diversity goal;
selecting, by the device, a particular employment diversity plan from the set of employment diversity plans; and
providing, by the device, information identifying the particular employment diversity plan via a user interface.

16. The method of claim 15, further comprising:
determining, for the set of employment diversity plans, a set of likelihoods of achieving the employment diversity goal; and
where selecting the particular employment diversity plan comprises:
selecting the particular employment diversity plan based on the set of likelihoods of achieving the employment diversity goal.

17. The method of claim 15, further comprising:
determining, for the set of employment diversity plans, a set of cost metrics associated with implementing the set of employment diversity plans; and
where selecting the particular employment diversity plan comprises:
selecting the particular employment diversity plan based on the set of cost metrics.

18. The method of claim 15, further comprising:
determining, based on the employment information, that the employment diversity goal is achievable during the particular timeframe without altering a hiring rate of employees or an attrition rate of employees,
the particular employment diversity plan being associated with maintaining the hiring rate of employees and the attrition rate of employees; and
where selecting the particular employment diversity plan comprises:
selecting the particular employment diversity based on the particular employment diversity plan being associated with maintaining the hiring rate of employees and the attrition rate of employees.

19. The method of claim 15, further comprising:
receiving, via the user interface, information associated with causing a change to the particular employment diversity plan;
generating another employment diversity plan including the change to the particular employment diversity plan; and
providing the other employment diversity plan via the user interface.

20. The method of claim 15, where the employment diversity goal relates to reducing a gender imbalance among the portion of the workforce of the company; and
where the method further comprises:
identifying a first promotion rate for male employees and a second promotion rate for female employees;
determining that the first promotion rate and the second promotion rate are different rates; and
where selecting the particular employment diversity plan comprises:
selecting the particular employment diversity plan to cause the second promotion rate to be closer to the first promotion rate.
